(19) United States
(12) Patent Application Publication
(10) Pub. No.: US 2009/0187497 A1
(43) Pub. Date: Jul. 23, 2009

(54) Electronic Register

(76) Inventor: Miriam Evelyn Salcedo, McAllen, TX (US)

Correspondence Address: Miriam Evelyn Salcedo, 611 Orange Street, McAllen, TX, 78501, US

(21) Appl. No.: 12/018,053

(22) Filed: Jan. 22, 2008

(51) Int. Cl. G06Q 40/00

(52) U.S. Cl. 705/30

(57) ABSTRACT

This invention pertains to software that is created to manage financial data. This invention focuses on electronically managing accounts that the user has with a financial institution. The invention would replace paper transaction registers. The invention is an electronic version of the paper register. This invention helps account holders manage accounts in real time both accurately and quickly. The user would enter transaction information as it occurs in real time and the software would calculate and store the information. The user would then have the option to transfer/send that information to another user with the push of a button. The user on the receiving end will be able to view the latest transaction and the changes it made to the account. People that share an account at a financial institution will be able to better balance their accounts by updating each other of any transactions with this invention.

### BRIEF SUMMARY OF THE INVENTION

The Electronic Register is software that can be installed or downloaded into computers or electronic devices. The Electronic Register maintains and computes financial data and allows the user(s) to manage date(s), check number(s), description(s) of transaction(s), balance(s), payment(s), debit(s), fee(s), deposit(s), credit(s) and other financial related information entered into the computer(s) or electronic device(s). The object of the Electronic Register is to allow user(s) to electronically keep record of finances and transactions as they occur.

### BRIEF DESCRIPTION OF THE SEVERAL VIEWS OF THE DRAWING

FIG. 1 depicts what the user will see on the screen of a computer or a hardware device when the software is open.

FIG. 2 depicts a hardware device or independent personal device created solely for the invention. The top half of FIG. 2 is the screen that the user will view the software on. The bottom half of FIG. 2 shows buttons that the user can use to enter data into the device.

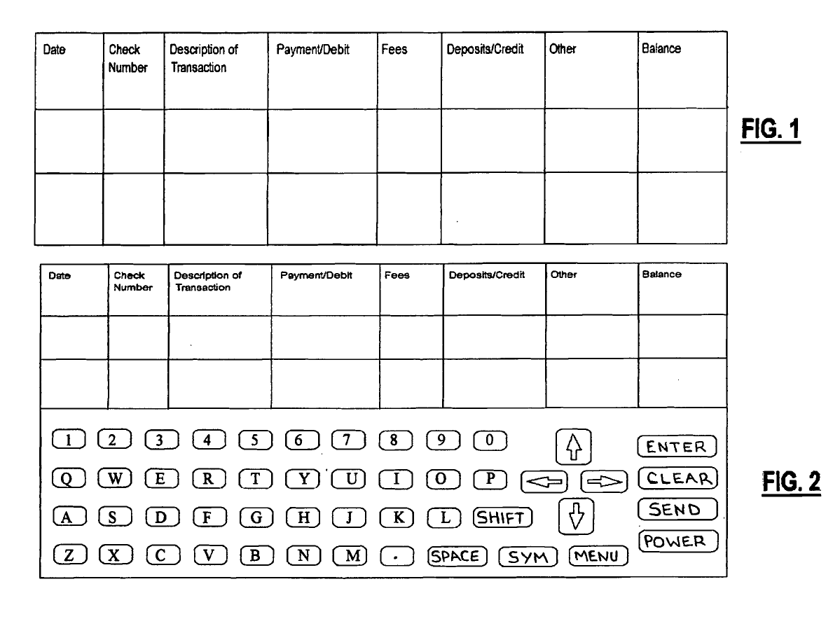

### DETAILED DESCRIPTION OF THE INVENTION

The Electronic Register maintains and computes financial data and allows the user(s) to manage date(s), check number(s), description(s) of transaction(s), balance(s), payment(s), debit(s), fee(s), deposit(s), credit(s) and other financial related information entered into the Electronic Register.

The Electronic Register is an electronic version of a paper transaction register usually given by financial institutions.

The Electronic Register is software that can be installed or downloaded into a computer.

The Electronic Register is software that can be included into other electronic or computer device(s) by installing it or downloading it.

Independent personal devices can be created solely for this software.

Once the software is installed or downloaded, information can be entered in to and from the Electronic Register.

Information can be entered manually in to the Electronic Register.

Information can also be uploaded/transferred to and from the individual's computer via a cord (one example of a “cord” would be a USB cord) to the Electronic Register.

The Electronic Register can also receive information from the internet w/out cords by using technology similar to a wireless computer or a PDA (Personal Digital Assistant).

The Electronic Register can be installed or downloaded into any independent personal device(s) so that the user(s) can record information from any location at any time.

The Electronic Register allows the user(s) to maintain information in one independent personal device.

The Electronic Register allows the user(s) to send and receive information from one independent personal device to another independent personal device by using technology similar to text messaging and emailing.

The Electronic Register allows the user to transfer information to and from an independent personal device to a computer.

The Electronic Register allows the user to transfer information to and from an independent personal device to the internet.

What is claimed is:

1. A software that can be installed or downloaded into computers or hardware devices with the purpose of maintaining and computing financial data.

2. The invention electronically manages and balances an account accurately and in real time by allowing the user to enter transactions as they occur.

3. The invention allows the user to share account information with another user by sending and receiving data from one hardware device to another electronically.
